(19) United States
(12) Patent Application Publication
(10) Pub. No.: US 2017/0287028 A1
(43) Pub. Date: Oct. 5, 2017

(54) A CUMULATIVE SALE SYSTEM IN COMMUNAL LIFE SPACES AND A METHOD THEREFOR

(71) Applicant: INANLAR INSAAT ANONIM SIRKETI, Istanbul (TR)

(72) Inventor: Serdar INAN, Istanbul (TR)

(73) Assignee: INANLAR INSAAT ANONIM SIRKETI, Istanbul (TR)

(21) Appl. No.: 15/511,245

(22) PCT Filed: Sep. 22, 2015
(86) PCT No.: PCT/TR2015/000323

§ 371 Date: Mar. 15, 2017

(30) Foreign Application Priority Data
Sep. 29, 2014 (TR) 2014/11484

(51) Int. Cl. G06Q 30/06

(52) U.S. Cl. CPC G06Q 30/0605

(57) ABSTRACT

The invention is a cumulative sale system which enables to provide the goods or services by using overall purchasing power of people living in communal life spaces such that the mutual interests are allowed to be balanced in terms of the manufacturer and/or vendor. It includes software platform which operates within a life space server connected by a network of communal life space consisting of clients that are any one or more of information processing devices such as a computer, a smart phone, a local client specific for the flat which will be used by the residents of communal life space and which is connected via a telecommunication network such as internet, wireless communication, etc., wherein in this software platform the residents of the life space may indicate which cumulative purchasing power of goods and services they desire to use or they can make choice among the previously available options.

### CROSS REFERENCE TO RELATED APPLICATIONS

This application is the national phase entry of International Application No. PCT/TR2015/000323, filed on Sep. 22, 2015, which is based upon and claims priority to Turkish Patent Application No. 2014/11484, filed on Sep. 29, 2014, the entire contents of which are incorporated herein by reference.

### TECHNICAL FIELD

The present invention relates to a cumulative sale system and a method therefor which enables the most advantageous trading between the trade parties such as manufacturers, vendors and consumers by using the purchasing power of the people coining together in a particular location in a cumulative way.

More specifically, the present invention relates to a system which enables selling of the goods or services by using overall purchasing power of people living in a large and overpopulated residential area in which the construction sector and site settlement have increased such that the mutual interests are allowed to be balanced in terms of the manufacturer and vendor.

### BACKGROUND

Increase of communal life spaces causes traditional shopping methods to be questioned due to the fact that the construction sector technologies enable the generation of comfortable life spaces which bring more people together as compared to the past. Larger city groups have started to take the place of sites which are remembered when it comes to life spaces and which bear the village population.

Currently, no method has been developed exactly which makes use of purchasing (shopping) potential of people living in these large life spaces. In general, arrangements limited to the campaigns performed by the markets and department stores located in said space are not fully exploited by both vendor and customer. In particularly, advertisement, presentation and publicity which are unpleasant for the vendor and manufacturer to catch the customer as well as efforts in sales and marketing continue to increase the product cost.

Developing manufacturing technologies have made it possible to minimize the costs arising from product manufacturing. Raw material and manufacturing costs have been reduced to maximum available level even in high-quality products while the sales and marketing of these products, in other words the cost increase at a period of time during which the product arrives to the consumer, are the most important sale reasons. In the communal life spaces (communal living environment) there are numerous expenditures. These expenditures vary depending on the opportunities provided by the life space and in the worst case the expenditures such as a need for a janitor at a site and common electricity, water bills, etc. lead to these costs. When there are pools, sport complexes, social areas in said life space these costs increase to higher levels and occasionally reach rental expenses of a middle class family living in a metropolis. As a result when the families who bought a house not to pay a regular rental expense desire to improve the quality of their lives and move to a well-equipped life space they may encounter a common space cost or service charge that is almost close to their rental expenses.

Today's human being has still not created structures in which mutual interests may be achieved by increasing the cumulative (communal) purchasing capability. However, the Internet-based shopping and communication systems which increase with the development of today's telecommunication and information processing technologies, as well as social networks may be readily used as part of the system in this field.

With reference to state of the art triple-transition analysis term discloses the satisfaction of human requirements and the development process of the shopping habits. This process basically is a natural consequence of a demand occurring due to history of humanity. The first term called “the Production Term” is a term in which the production is very difficult and there is a limitation for the transport of any raw materials to the production area and subsequently for the transport of produced good or service to the consumption area. Regardless of what is produced, the more difficult the transport of goods to the consumption area was, the easier was the sale of the goods. Also, only the production, safety of the production and the logistics were focused without any sale concerns since there were problems in safety of the production. In other words the ones who were able to produce were successful. As a result of this process the production areas developed over time and the second term started. The second term is called “the Vendor Term” In this term the logistics made progress, individuals were able to transport the goods that they produced to the consumption areas and the production amounts were extremely increased via mechanization. Also in this term safety of the production was planned and achieved. From now on the production and the consumer were able to meet. This initially caused a boost in consumption and as a natural consequence the production amounts were increased such that people could not sale their products. In this term establishment of hypermarkets and shopping malls was seen. The manufacturers queued in front of such selling points to sell their goods and services. In this term the one who sold became a winner. The third term is called “the Consumer Term”. This is a term in which the shopping malls were overspread. The consumer established the rules. In this term the consumer was the master and everyone had to get the good and service thereof to the consumer. Various production and sale strategies were tried and the consumer chose one of them to his/her delight. In this context communal living environments has gained importance. In other words, the fields of production were important in the first term and the fields of sale were important in the second term whereas the fields of consumption were important in the last term. As consumption is seen in the places where there are people the importance of every communal living environment in which people live will increase. These communal living environment entities will have a chance to make special agreement of the present patent that is to be executed between such manufacturer and vendor. The last term is a term in which the vendor fades from the scene and the manufacturer and the consumer is alone together. In this term all sales spaces will be removed, and the manufacturer and the consumer of communal living environment will mutually make an interest agreement. Similarly, in prior art clearance sales (reduced), discounts for special days, individual discount cards (customized discounts), interest methods paid from the vendor to the unit mediating the sale procedure via the Internet and communal purchasing methods performed jointly by the business firms may be denoted.

However, none of these methods have structures and mechanisms which enable both direct transfer of opinions and thoughts of individuals living in communal life space and flexible solutions via a central management and also which allow to directly or indirectly obtain and distribute interests to the parties (the manufacturer, vendor, consumer or customer).

One of the most important technical problems is that the residents, families and individuals living in communal life spaces have not different choices for the interests to be obtained differently from common purchases of the firm. For example there is no system which enables the above-mentioned service charges or common expenditures of life space to be automatically covered directly as a result of said interests to be obtained. Getting service charges and receiving cash with respect to a required common expenditure other than the service charge are time-consuming and exacting and are one of the most important problems that force site managers to suspend their jobs. By solving this problem via such cumulative sale system or sale technique, site and life space managers as well as the residents (owners of flats, houses, residence) will feel relax.

### SUMMARY OF THE INVENTION

The object of the invention is to provide a cumulative sale system and a method therefor which enables providing the goods or services by using overall purchasing power of people living in communal life spaces such that the mutual interests are allowed to be balanced in terms of the manufacturer and/or vendor.

### BRIEF DESCRIPTION OF THE DRAWINGS

FIG. 1 shows a representative scheme which describes the way of information transfer to a central system server of the clients, vendors, manufacturers and licensed entity used by the residents living in the life space for the cumulative sale in communal life spaces in order to allow the system of the invention to be understood.

FIG. 2 shows a flow chart relating to the operating principle of the system of the invention.

FIG. 3 shows a representative scheme which describes the parties of the system of the invention and the interaction between them.

### REFERENCE NUMBERS

10. Network of communal life space (consumer client network)

20. Server of life space

30. Telecommunication network

40. Server of cumulative sale system

50. Database

60. Client of licensed entity

70. Manufacturer client

100. Approval of the agreement between communal life space management and the licensed entity in the cumulative sale server.

110. Reporting the interest utilization and product choices of the life space clients to the server.

120. Obtaining cumulative sale offers from the manufacturer and vendor clients.

130. Evaluation and approval of the offers by the licensed entity.

140. Sharing the approved offers with the life space management and residents and submitting the same for approval.

150. Reporting the final approvals from the residents and/or management to the server.

160. Enabling the consumers to shop via the Internet, a mobile application, a direct sale or a point of sale while presenting the agreement reference.

170. Utilization of the interest obtained as a result of shopping processes (service charge, distribution in cash, etc.)

200. Communal life space

210. A person or an institution authorized to represent communal life spaces.

220. An authorized person or institution (licensed entity)

230. Manufacturer and/or vendor

### DETAILED DESCRIPTION OF THE INVENTION

The present invention relates to a system which enables providing the goods or services by using overall purchasing power of people living in a large and overpopulated residential areas provided by qualified life spaces and site settlement which arise from the construction technologies such that the mutual interests are allowed to be balanced in terms of the manufacturer and/or vendor in order to take the advantage of living together.

The consumer groups and the manufacturers as well as vendors belonging to distribution network thereof may able to gain substantial profits by virtue of the cumulative sale system of the invention. The manufacturer and the business organizations belonging to sales network thereof save substantial effort that they spent to present their products to the consumers while they make a substantial profit economically in the context of the space and human resource. The manufacturer may present the product thereof by a stable sales trend as a consequence of an agreement to be made directly with the consumer group.

Currently, the sale value occurring due to the transport of the manufacturer's products to the consumer during the sale chain and thus, some of prime costs (advertisement, sale network, store rent, the required human resource and the other costs therefor) imposed to the consumer are returned to the consumer via the system and the method of the invention. The consumer may have a chance to use the advantages to be obtained from said sales agreement in a flexible manner. The most important advantage in the system of the invention is that the functionality of the system is increased by using the benefit received by the consumer for bearing the expenditures of the life space (communal living environment). For example when the site residents make an agreement with a branded product manufacturer or distributor the resulting material benefit is likely used for the expenditures such as service charge, etc. required for management of said life space rather than being returned to the consumer in cash.

The process flow relating to the cumulative sale method of the invention can be summarized as follows:
1. Making a cooperation agreement between a person or an institution (licensed entity) authorized to use the method of the invention and a person or an institution authorized to represent communal life spaces such as customer's site, builds, etc.,
2. Obtaining the cumulative purchasing offers relating to various products that are contained in a class suitable for the general choices of the population and that are needed the life space from vendors in the manufacturer and/or sale networks,
3. Announcing the approved offers to the consumer,
4. Ordering the products relating to the approved offers via various channels or by purchasing them directly from the respective point of sale,
5. Reflecting the interest obtained in accordance with the agreement to the product price and/or using the interest directly for the expenditures of communal life space.

The licensed entity consists of natural and legal persons authorized to use the system of the invention and is entitled to arrange the cumulative sale agreements along with the system access. Thus, an agreement is made between a licensed entity authorized to use the system of the invention and people or the ones who are entitled by those people (site manager, etc.) according to the rules determined by the system in order to determine the terms of the cumulative sale agreement relating to a life space.

The individuals in the life space may agree upon that according to which principles the cumulative sale system will be done for the life space thereof by coming together in a site meeting. In addition, the individuals may present their opinions over a user-friendly interface by logging in the system without such meeting owing to the information processing provided by the system of the invention. Thus, the terms of the cumulative sale agreement are determined while opinion of each individual who will be a party for that agreement in communal life space is taken into consideration. Accordingly, the individuals may directly take the advantage of discount during purchase of goods and services as a result of the agreement to be made, or may instead determine that the interest to be obtained as a result of the agreement is used for the service charge and the expenditures relating to the common spaces.

The licensed entity may make cumulative sale agreements as a representative of the individuals living in the life space within the determined rules. In this context the system of the invention enables the manufacturer who desire to make sell or the representatives thereof to be introduced to the system and to enter their price offers. The evaluation of the offers obtained with respect to the goods and services having different tradenames and qualities may also be carried out in accordance with the agreement between the licensed entity and the resident of communal life space. Here, it may be provided that the licensed entity is authorized and all evaluations may be carried out by the licensed entity; however the residents of the life space may desire to indicate their choices. For this all offers have to be introduced to the system by the manufacturers and the vendors till a given period, i.e. the due date and the last hour. Then the residents of the life space are allowed to make choices and to perform sorting by examining the offers in a given period. Finally, the system which compiles all such data provides sufficient information to allow the licensed entity to make a decision by providing the choices that the consumers desire to make about the products. The licensed entity obtains an agreement including the additional offer conditions to be given in the offers along with the predefined agreement principles by making its choice or choices via this system. Upon signing the agreement by the parties the respective approvals is provided to the system and the cumulative sale agreement is completed.

Discounts gathered in the manufacturers and the vendors during given periods determined by the agreement are controlled by said licensed entity (the entity which is a party of the cumulative sale agreement and which represents the population in the life space). It is provided that the common expenditures of the life space are covered and an investment is made for the life space (environmental planning, pergola, road, sport center, etc.), or the resident of the life space are allowed to make a different utilization according to the choices thereof Accordingly, an opportunity may be given for the relatives of the life space residents to benefit from the interests.

If the interests are gathered indirectly rather than being directly it is also possible that the material things to be obtained may be deducted from the service charge of the life space. Said licensed entity calculated the interest obtained from the vendor or the manufacturer and shares it with the manager of the life space (site management), thereby it is deducted from the service charges of the flats or residences in which the residents live. If the amount of the interest is greater than the amount of the service charge it can be used in life space investments or in different common expenditures; however it can be paid to the residents in cash.

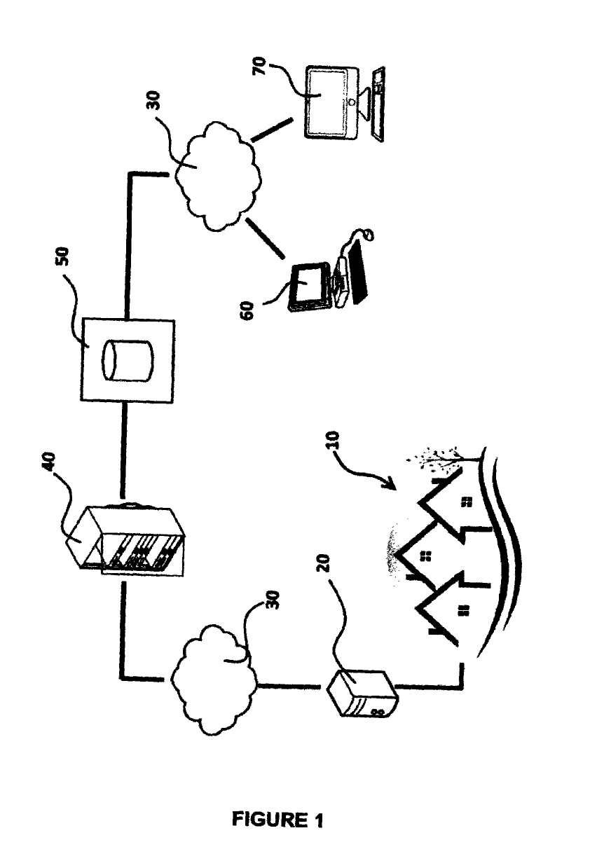

In FIG. 1 there is shown a representative diagram of a network (10) of communal life space which describes the way of connection of the manufacturers and the vendors as well as the licensed entity authorized to use the cumulative sale system of the invention to a server (40) of the cumulative sale system and to a database (50) operating thereon. As seen herein, a network of communal life space (consumer client network) (10) consisting of clients that are any one of information processing devices such as a computer, a smart phone, a local client specific for the flat which will be used by the residents of communal life space is operated by a software platform which operates in a life space server (20) and which is connected via a telecommunication network such as the internet, wireless communication, etc. The residents of the life space may indicate the goods and services, the purchasing power of which is desired to use by virtue of the software platform operation on said life space server (20), or they may make choices among previously available choices. The residents of the life space may have an identity profile as an individual or a family, or in the name of flat or residence in which they live and may connect to said server (20) with a password given by a manager. Said manager may be an individual or an institution authorized to represent the entire life space. Said authorized life space management may have access to the management software operating on said life space server (20) and may control the authority of the other users. In the system of the present invention there is a cumulative sale system server (40) which has a limited access for the life space management and has a unlimited access only for the licensed entity and also which is connected by the clients via a communication network (30) such as remote internet or wirelessly, etc., and a common database (50) operating thereon. In said database (50) the profile information of the life space residents obtained from said life space server (20) and purchasing choices and demands thereof are recorded. Moreover, in said database (50) life space managements of the licensed user client (60) and the agreements and contracts thereof made with the manufacturers/the vendors are also recorded. In addition, the manufacturers and/or the vendors may record offers, or demands and proposals to be given via the system, marketing opinions and the product promotions thereof to said database (50) and update them by connecting to the server (40) of said cumulative sale system remotely.

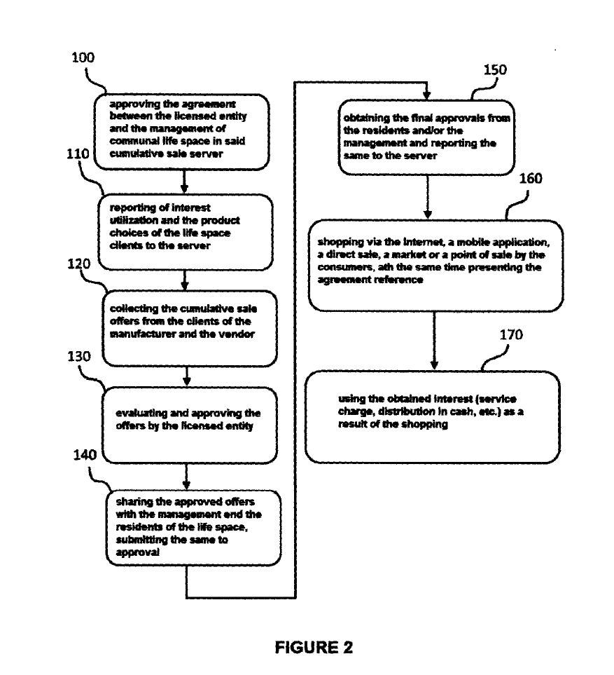

With reference to the flow chart of FIG. 2 the cumulative sale method of the invention may be described as follows: approving (100) the agreement between the licensed entity and the management of communal life space in said cumulative sale server, reporting (110) of interest utilization and the product choices of the life space clients to the life space server and recording of the same to a database (50) operating in the cumulative sale system server (40), collecting (120) the cumulative sale offers from the clients of the manufacturer and vendor, evaluating and approving (130) the offers by the client of the licensed entity, sharing the approved offers with the management and the residents of the life space and submitting (140) the same to the approval, obtaining the final approvals from the residents and/or the management and reporting (150) the same to the life space server, shopping via the Internet, a mobile application, a direct sale, a market or a point of sale by the consumers and at the same time presenting (160) the agreement reference, using (170) the obtained interest (service charge, distribution in cash, etc.) as a result of the shopping.

The system of the invention and the method used in this system can be applied in communal life spaces such as sites, housing estate centers, buildings, etc. as well as in communal spaces such as business centers, industrial estates, organized industrial zones, free zones, etc. During implementation of the system and the method a user-friendly interface, a website, digital and non-digital electronic instruments can be used in addition to the basic factors and they may vary.

One of the most important advantages of the invention is that purchasing potentials of people living in communal life spaces can be used and as a result of this special interests that are not contained in prior art may be presented. A kind of social consensus can be built between the manufacturer who produces and develops a product, the vendor who submits the products to the consumer via various routes and channels and the consumer.

Costs undertaken by the manufacturers and the vendors for representing the goods and services to the consumers thereof are reflected to the sale price of the products and thus, they are returned generally to the consumers as a cost. These costs include advertisements, human resource and even indirect distribution costs. Minimizing these costs provides substantial profits for the consumers.

Accordingly, there are many ad-free sales networks (Networks) particularly developed in U.S.A. These sales networks use a distribution method which is created in the consumer without any advertisement costs and thus, cause the consumer to support the sale and marketing procedures and earn money. On one hand this however requires advanced communication skills and the other hand it can harm the neighborhood's and friendship's sincerity of people of our country. The old friendships can be stuck in a difficult situation due to the fact that the friendships are commercialized or minor problems may occur in businesses.

However a person can simply be included in the system by choosing the only good or service of which he desires to take advantage from a platform and by making suggestion owing to the present invention without having any sale skills. Nowadays where the social networking is increased said platform can be managed by the easiest methods by moving to the social networks which are accessed by the residents of communal life spaces.

It is possible that the manufacturers and the vendors can manage the costs such as advertisement, marketing, etc. more easily by means of the agreements within the present invention, they can reduce the costs and they enable the system to spread quickly and to be used effectively by directing the interest to be obtained to their customers with whom they made an agreement. Moreover the problems such as stock instability, etc. can be eliminated as more organized and systematic consumption period has been reached.

In addition there is a more equitable distribution of cost according to the consumption amount and the agreement. The users who are members of the system of the invention and external consumers will have substantial discount and advantage differences.

Moreover, the residents of communal life space who use the system of the invention by making an agreement may obtain interests in favor of themselves even if they buy said products from a near market. The contracted consumer shopping with a standard price during a market shopping can have the interest which will be obtained due to the difference between the agreed price and the standard price for using in the common expenditures of the site (service charge), or directly as an income at given periods. As a consequence the cumulative sale system of the present invention is a sale and distribution method which enables mutual interest between the manufacturer, the vendor and the consumers based on a win-win principle.

The invention is a cumulative sale system which enables providing the goods or services by using overall purchasing power of people living in communal life spaces (200) such that the mutual interests are allowed to be balanced in terms of the manufacturer and vendor. There is a software platform, a cumulative sale system server (40) and a common database (50), wherein the software platform operates within a life space server (20) connected by a network of communal life space (consumer client network) (10) consisting of clients that are any one or more of information processing devices such as a computer, a smart phone, a local client specific for the flat which will be used by the residents of communal life space and which is connected via a telecommunication network (30) such as the internet, wireless communication, etc., wherein in this software platform the residents of the life space may indicate which cumulative purchasing power of goods and services they desire to use or they can make choice among the previously available options; wherein the cumulative sale system server may be connected by the clients (10, 60, 70) via remote internet or wirelessly, etc.; and wherein the common database operates on the cumulative sale system server and records the profile information of the life space residents obtained from said life space server (20), purchasing choices and demands thereof, the life space managements of the licensed client (60) and the agreements thereof made with the manufacturers/vendors, and/or the offers to be made by connecting to said cumulative sale system server (40) remotely in the manufacturers and/or the vendors or their demands and proposals to be given via the system, marketing opinions and the product promotions.

In said cumulative sale system servers the following steps are included: approving (100) the agreement between the licensed entity and the management of communal life space, reporting (110) of interest utilization and the product choices of the life space clients to the life space server and recording of the same to a database (50) operating in the cumulative sale system server (40), collecting (120) the cumulative sale offers from the clients of the manufacturer and vendor, evaluating and approving (130) the offers by the client of the licensed entity, sharing the approved offers with the management and the residents of the life space and submitting (140) the same to the approval, obtaining the final approvals from the residents and/or the management and reporting (150) the same to the life space server, shopping via the Internet, a mobile application, a direct sale, a market or a point of sale by the consumers and at the same time presenting (160) the agreement reference, using (170) the obtained interest (service charge, distribution in cash, etc.) as a result of the shopping.

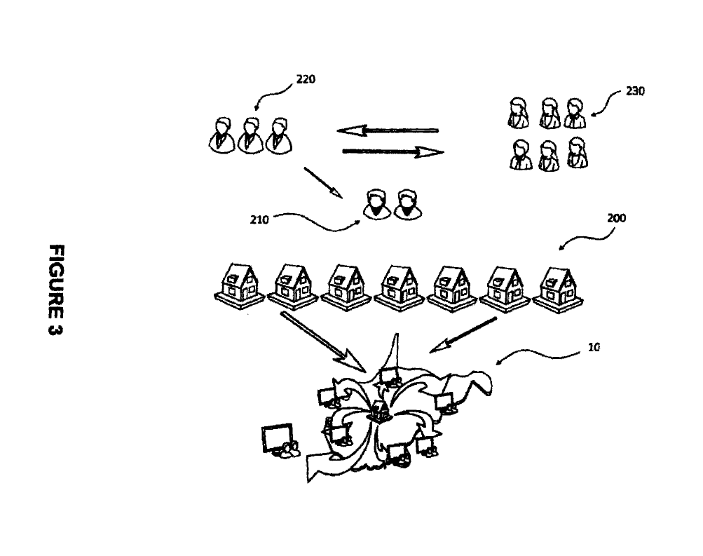

According to the interaction between the parties of sale method in FIG. 3, the method of the present invention is used in: an authorized person or an institution (the licensed entity) (220) and the communal life spaces (200) such as sites, buildings, etc. in which the consumers of communal life space network (10) live, making an arrangement between a person and an institution (210) which are authorized to represent communal life spaces, obtaining the cumulative purchasing offers relating to various products that are contained in a class suitable for the general choices of the population and that are needed in the life spaces from vendors (230) in the manufacturer and/or sale networks, announcing the approved offers to the consumer connected to the network of communal life space (10), ordering the products relating to the approved offers via various channels or by purchasing them directly from the respective point of sale by the consumers connected to the network of communal life space (10), reflecting the interest obtained in accordance with the agreement to the product price and/or using the interest directly for the expenditures of communal life space such as service charge, etc.

The system of the invention and the method used in this system can be applied in communal life spaces such as sites, housing estate centers, buildings, etc. as well as in communal spaces such as business centers, industrial estates, organized industrial zones, free zones, etc. During implementation of the system and the method a user-friendly interface, a website, digital and non-digital electronic instruments can be used in addition to the basic factors and they may vary.

1-3. (canceled)

4. A cumulative sale system, which enables to provide goods or services by using an overall purchasing power of people living in a communal life space such that mutual interests are allowed to be balanced in terms of a manufacturer and a vendor, the system comprising:
a software platform, which operates within a life space server connected by a network of the communal life space consisting of clients, wherein at least one information processing device is used by residents of the communal life space and is connected via a telecommunication network; wherein in this software platform, a cumulative purchasing power of the goods and services is selected to be used or a choice among previously available options is made;
a cumulative sale system server, to which all clients are connected via a communication network and a database which operates thereon; and
wherein profile information of life space residents obtained from said life space server, purchasing choices and demands thereof, the life space managements of the licensed user client and the agreements thereof made with at least one of the manufacturers or vendors as well as the offers to be made by connecting to said cumulative sale system server remotely in the manufacturers and/or the vendors or their demands and proposals to be given via the system, marketing opinions and the product promotions are recorded.

5. A method of operating a cumulative sale system, which enables to provide goods or services by using an overall purchasing power of people living in a communal life space such that mutual interests are allowed to be balanced in terms of a manufacturer and vendor, the method comprising:
approving an agreement between a licensed entity and a management of communal life space in the cumulative sale server;
reporting an interest utilization and product choices of life space clients to a life space server and recording the interest utilization and product choices in a database operating in the cumulative sale system server;
collecting cumulative sale offers from clients of the manufacturer and the vendor;
evaluating and approving the offers by a client of the licensed entity;
sharing approved offers with a management and residents of the life space and submitting the approved offers for an approval;
obtaining final approvals from the residents and/or the management and reporting the final approvals to the life space server;
shopping via an internet, a mobile application, a direct sale, a market or a point of sale by consumers and at the same time presenting an agreement reference;
using obtained interests as a result of the shopping.

6. A method of operating a cumulative sale system, which enables providing goods or services by using an overall purchasing power of people living connected to a network of a communal life space in communal life spaces such that mutual interests are allowed to be balanced in terms of a manufacturer and/or a vendor, the method comprising:
making a cooperation agreement between a person or an authorized institution and a person or an institution authorized to represent communal life spaces, in which consumers living connected to the network of communal life space;
obtaining cumulative purchasing offers relating to various products that are contained in a class suitable for general choices of a population and that are needed in the life spaces from vendors in manufacturer and/or sale networks;
announcing approved offers to the consumers connected to the network of communal life space;
ordering the products relating to the approved offers via various channels or by purchasing the products directly from a respective point of sale by the consumers connected to the network of communal life space;
reflecting interests obtained in accordance with the agreement to a product price and/or using the interests directly for expenditures of the communal life space.
